(19) United States
(12) Patent Application Publication
(10) Pub. No.: US 2013/0228054 A1
(43) Pub. Date: Sep. 5, 2013

(54) Method and Apparatus for Multi-Track Slicing of Food Products

(71) Applicant: Dietmar Bohlen, Ober-Morlen (DE)

(72) Inventor: Dietmar Bohlen, Ober-Morlen (DE)

(73) Assignee: WEBER MASCHINENBAU GMBH BREIDENBACH, Breidenbach (DE)

(21) Appl. No.: 13/597,976

(22) Filed: Aug. 29, 2012

(30) Foreign Application Priority Data
Sep. 1, 2011 (DE) 102011112171.8

(51) Int. Cl. B26D 7/00

(52) U.S. Cl. CPC B26D 7/00
USPC 83/13; 83/167

(57) ABSTRACT

The present invention relates to a method for multi-track slicing of a plurality of food products, in particular food products of different types, into respective part portions including at least one product slice, wherein a respective product is supplied to a cutting plane in at least two parallel tracks of a slicing apparatus and is sliced by means of a cutting blade which can in particular be moved in a revolving manner, wherein the slices of the at least two products cut off by the cutting blade fall onto a common, movable storage table, wherein only one respective product supplied in one of the tracks associated with the common storage table is exclusively sliced at any one time so that a maximum of one slice of the just sliced product falls onto the common storage table at any one time.

The present invention relates to a method for multi-track slicing of a plurality of food products, in particular food products of different types, into part portions respectively comprising at least one product slice, wherein a respective product is supplied to a cutting plane in at least two parallel tracks of a slicing apparatus and is sliced by means of a cutting blade which is in particular moved in a revolving manner, wherein the slices of the at least two products cut off by the cutting blade fall onto a common, movable storage table.

The invention furthermore relates to an apparatus, in particular a high-performance slicer, for multi-track slicing of a plurality of food products of different types, into part portions respectively comprising at least one product slice, comprising a product feed which has at least two parallel tracks, with a product being able to be supplied in each track to a cutting plane individually by a track; at least one cutting blade which is movable, in particular in a rotating or revolving manner, in the cutting plane; and a movable, common storage table which is disposed after the cutting plane and onto which the slices of the at least two products cut off by the cutting blade can fall.

Consumers are becoming increasingly more demanding, This also applies to purchasers of packed food slices. Consumers increasingly want slices of different products or of products of different types to be packed together. It is, for example, desired that different types of sausage or different types of cheese are included in one packet so that sausage slices and cheese slices can together also form a mixed total portion which is called a packaging unit here.

Such consumer desires can be satisfied in principle using conventional technology. Modern slicing machines, which are also called high-performance slicers, can slice food products extremely fast, with a very precise weight and extremely hygienically. Together with conveying technology known per se and packaging machines known per se, such slicers form efficient production lines with which food packets having a plurality of food slices can be produced.

To manufacture “mixed packages” of slices of different products, a plurality of slicers are used in accordance with the prior art which each slice one kind of product or one product type. The individual product flows of the slicers are subsequently combined to produce the mixed packets.

The product throughput can be increased by the use of slicers which can slice a plurality of products simultaneously since a plurality of products can be sliced simultaneously with them. The manufacture of the mentioned “mixed packets” is, however, complex, with such slicers, above all when the slices of a mixed packet should be packed in a manner which appeals to the consumer.

It is the underlying object of the invention to expand the possibilities in the slicing of food products, with it in particular being possible to manufacture “mixed packets” of slices of different food products, in particular of products of different types, which appeal to the consumer, as simply, as reliably and as inexpensively as possible.

This object is satisfied by a method having the features of claim 1 and in particular in that only one product supplied in one of the tracks associated with the common storage table is respectively sliced at any one time so that a maximum of one slice of the just sliced product is incident on the common storage table at any one time.

It is thus the underlying idea of the invention that two or more tracks of a slicing apparatus are associated with a common storage table on which the cut-off slices of the products supplied to the cutting plane in these tracks are placed down. In this respect, only one product which is supplied in one of the tracks associated with the common storage table is exclusively sliced at any one time. The other products which are supplied in the other associated track or tracks are thus not simultaneously sliced. Since a maximum of one slice of the just sliced product falls onto the common storage table at any one time in this manner, the common storage table can be moved relative to the falling slice such that the respective slice is incident on the storage table at a specific point and/or in a specific manner. The slices can thus be placed down on the storage table in a desired position one another the other and in a manner appealing to the consumer.

A portion is preferably formed on the common storage table which respectively includes at least one part portion of each of the supplied products. Every product which is supplied in one of the tracks associated with the common storage table thus respectively forms at least one part portion on the storage table. Since products of different types are normally supplied, the part portions from a mixed portion together on the storage table.

A part portion comprising a plurality of slices is preferably prepared on the storage table completely from one product supplied in a track, before the preparation of a part portion comprising a plurality of slicers from a product supplied in a different track is started. Slices of a product supplied in one track are thus cut off for so long until the respective part portion is complete. Only then is the slicing of the next product started. Dead times and/or blank cuts due to the moving to the next product can thereby be kept small.

In a preferred further development of the invention, the common storage table is moved relative to the falling slices of a part portion such that the part portion is arranged on the storage table in a specific laying pattern. The part portion can therefore in particular be formed on the storage table in a laying pattern which appeals to the consumer.

The laying pattern preferably satisfies at least one predefined condition for the respective part portion. The condition can, for example, be the position of the part portion on the storage table. The condition can also relate to the manner of the arrangement of each slice of the part portion. Provision can, for example, be made that each slice of the part portion should come to lie on the storage table folded onto itself or on edge. In addition, the condition can relate to the manner of the arrangement of the slices of the part portion relative to one another so that it can be predefined, for example, that the slices should come to lie on the storage table next to one another or in an overlapping manner.

The common storage table is preferably moved in a period in which no slicing takes place such that a part portion to be formed subsequently comes to lie in a specific position relative to a part portion already formed on the storage table. The part portions can thus be arranged in a desired position relative to one another on the common storage table.

In a preferred embodiment of the invention, the common storage table is rotated about an axis of rotation orientated perpendicular to the storage table so that the slices forming a part portion come to lie on the storage table in the form of a part circle. The respective part portion can thereby be prepared particularly simply on the storage table in a laying pattern of part circle form.

A first part portion which comprises the cut-off slices of a product supplied in a track is in particular prepared before a second part portion in time which comprises the cut-off slices of a product supplied in another track, with the common storage table being moved in the time period between the preparation of the two part portions such that the part circle formed by the slices of the first part portion is continued by the slices of the second part portion. A plurality of part portions can thus be arranged in a simple manner in a part circle, for example in a semi-circle.

In accordance with a preferred further development of the invention, the slicing apparatus has at least one further track in which a further product is supplied to the cutting plane and can be sliced by means of the cutting blade, with the cut-off slices of the further product falling onto a further, second storage table which is movable independently of the first storage table and on which the portion preparation takes place in the same manner as on the first storage table.

One or more tracks which are not associated with the first storage table, but rather with the second storage table, can thus be provided in the slicing apparatus. In this respect, the products which are supplied in the tracks associated with the second storage table are sliced in the corresponding manner as was described above with respect to the products which are supplied in the tracks associated with the first storage table. Only one product is thus likewise exclusively sliced in the tracks supplied to the second storage table at any one time. However, slicing can by all means also take place simultaneously in tracks which are associated with different storage tables.

It is particularly advantageous in this respect if part portions on the second storage table are prepared parallel in time with part portions on the first storage table since the slicing process can be shortened overall in this manner.

In accordance with a further preferred embodiment of the invention, the portions formed on the two storage tables are combined to form a packaging unit. The portions can thus be packed together.

The second storage table is preferably moved relative to the first storage table and can in particular be rotated about a specific angle to align the portion on the second storage table relative to the portion on the first storage table. A more pleasing appearance can thereby be achieved for the packaging unit formed by the two portions.

As was presented above—it is in particular possible for each part portion in the packaging unit to have a predefined laying pattern so that a packaging unit results overall which has an appearance pleasing to the consumer.

Each part portion can satisfy a predefined condition for the respective track which in particular relates to the weight of the part portion, to the weight and/or to the thickness of the slices forming the part portion and/or to the number of the slices forming the part portion.

The invention also relates to an apparatus, in particular a high-performance slicer, for multi-track slicing of a plurality of food products, in particular food products of different types, in part portions respectively comprising at least one product slice comprising a product feed which has at least two parallel tracks, with a product being able to be supplied in each track to a cutting plane individually by a track; at least one cutting blade which is movable, in particular in a rotating or revolving manner, in the cutting plane; and a movable, common storage table which is disposed after the cutting plane and onto which the slices of the at least two products cut off by the cutting blade can fall, wherein the apparatus is configured to slice only one respective product supplied in one of the tracks associated with the common storage table exclusively at any one time so that a maximum of one cut-off slice of the product just slices is incident on the common storage table at any one time.

The common storage table is preferably coupled with a controllable motor drive, whereby the storage table is movable relative to the falling slices of a part portion such that the part portion is arranged on the storage table in a specific laying pattern.

The storage table can be moved in a period in which no slicing takes place such that a part portion to be formed subsequently comes to lie in a specific position relative to a part portion already formed on the storage table.

The storage table is preferably designed as a turntable which is rotatable abut a vertical axis of rotation passing centrally through the turntable and/or is movable transversely to the longitudinal direction of the tracks.

The product feed can include at least on further track in which a further product can be supplied to the cutting plane individually by a track and the slices of the product supplied in the at least one further track cut off by the cutting blade fall onto a second storage table which is movable in the same manner as the first storage table and independently of the first storage table.

The apparatus is in particular configured for carrying out one or more of the steps of the method in accordance with the invention.

The term “type” used here is to be understood widely. For example, not only sausage and cheese or respective different kinds of meat, sausage or cheese of mutually different types should be formed in the sense of the invention. Products with the “same content” which differ from one another with respect to at least one parameter relevant from the view of the consumer should also be considered as products of different types. For example, salami with a small diameter, on the one hand, and salami with a large diameter, on the other hand, should thus represent different product types in the sense of the invention. In view of the fact that no two food products are identical in a strict sense, the term “type” is, in contrast, not to be understood so widely that differences between products are covered by it which the consumer either does not perceive at all or which are completely irrelevant for the consumer such as different distributions of the density or of the components of a product which are also naturally always present in products which are “the same” from the view of the consumer.

The invention will be described in the following by way of example with reference to the enclosed drawings. There are shown, schematically in each case

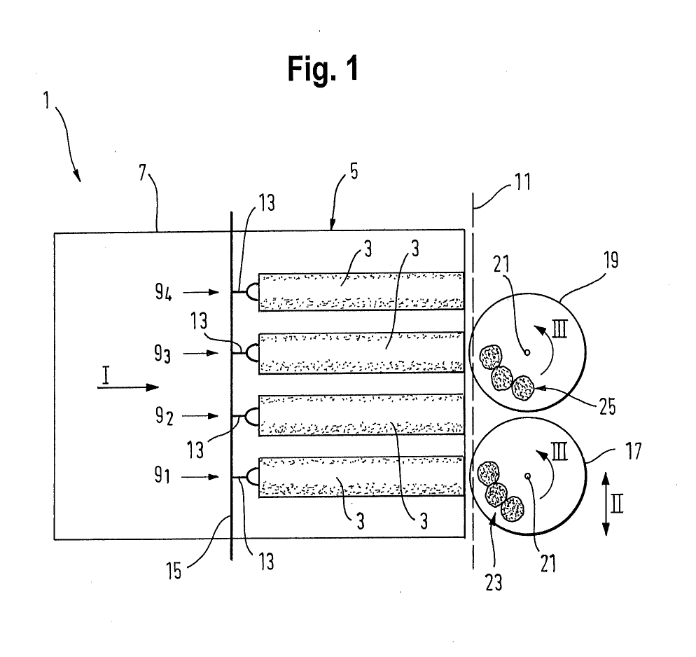

FIG. 1 a plan view of a slicing apparatus in accordance with the invention;

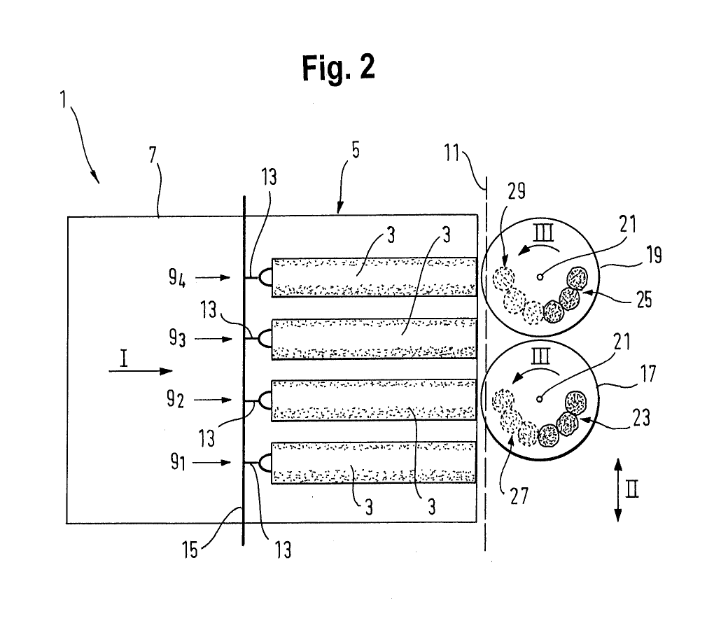

FIG. 2 a further plan view of the slicing apparatus in accordance with the invention of FIG. 1; and

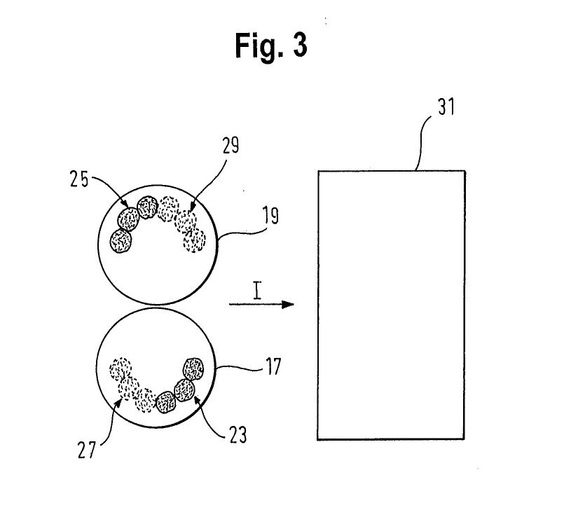

FIG. 3 a plan view of storage tables of the apparatus of FIG. 1 and of a packaging device disposed after the slicing apparatus.

The apparatus 1 shown is provided for multi-track slicing of a plurality of food products 3 and includes a product feed 5 having a product support 7 on which the products 3 can be supplied to a cutting plane 11—in the example shown—in four tracks 9₁, 9₂, 9₃, 9₄ lying next to one another. A cutting blade, not shown, by which slices can be cut off from the products 3 is arranged in the cutting plane 11.

The product feed 5 includes four product grippers 13 which are arranged at a carriage 15 which can be moved along the conveying direction I of the products 3. In this respect, a respective product gripper 13 engages in the rear end—viewed in the conveying direction I—of a respective product 3.

The products 3 can be supplied in the conveying direction I to the cutting plane 11 by the carriage 15 and the product grippers 13 arranged thereat. The product support 7 can also have a revolving conveying belt, not shown, on which the products 3 lie and by which the products 3 can be conveyed. In this case, the carriage 15 and the product grippers 13 do not serve for the product conveying in its actual sense. They are rather moved along with the products 3 conveyed by the conveying belt.

Each product gripper 13 is individually adjustable and can in particular also be moved against the conveying direction I. Each product 3 can thus be conveyed individually against the conveying direction I by the respective product gripper 13 engaging into the rear end of the product 3. The products 3 can thus be supplied in the tracks 9₁ to 9₄ to the cutting plane 11 individually by a track and can also be “pulled away” from the cutting plane 11 if required.

The apparatus 1 has a first storage table 17 and a second storage table 19 which are disposed after the cutting plane 11. In this respect, a first track 9₁ and a second track 9₂ are associated with the first storage table 17. Slices which are cut off from products 3 conveyed in these tracks fall onto the first storage table 17. A third track 9₃ and a fourth track 9₄ are associated with the second storage table 19 so that slices which are cut off from the products 3 supplied in these tracks can fall onto the second storage table 19.

The two storage tables 17, 19 are movable transversely to the conveying direction I (cf. transverse direction II). In addition, each storage table 17, 19 is rotatable about a vertical axis of rotation 21 extending through the respective table.

The apparatus 1 is configured for carrying out a preferred embodiment of the method in accordance with the invention. The operation of the apparatus 1 will be explained in the following.

In accordance with the above statements, the first storage table 17 is a common storage table for the first track 9₁ and for the second track 9₂. The second storage table 19 is a common storage table for the third track 9₃ and for the fourth track 9₄. In this respect in each case only one product 3 is exclusively sliced—with respect to the first and second tracks 9₁, 9₂. The product 3 is therefore sliced in the first track 9₁, while the product 3 in the second track 9₂ is not sliced (and vice versa). Correspondingly, likewise only one product 3 is exclusively sliced—with respect to the third and fourth tracks 9₃, 9₄.

The product 3 in the first track 9₁ is in particular supplied to the cutting plane 11, while the product 3 is “held” in front of the cutting plane 11 in the second track 9₂. This can be realized, for example, in that the product gripper 13, which engages into the rear end of the product 3 conveyed in the second track 9₂, pulls the product 3 away from the cutting plane 11, that is conveys it against the conveying direction I. In parallel to the product 3 in the first track 9₁, the product 3 in the third track 9₃ is supplied to the cutting plane 11, while the product 3 is held back in front of the cutting plane 11 in the fourth track 9₄.

Initially, therefore, only the products 3 in the first track 9₁ and in the third track 9₃ are sliced. The slices cut off from the product 3 in the first track 9₁ in this respect fall onto the first storage table 17 and there form a part portion 23. In this respect, the first storage table 17 is moved along the transverse direction II before the slicing so that the first storage table 17 is aligned in a specific manner relative to the first track 9₁ e.g. so that the middle of the first storage table 17 is arranged behind the product 3, viewed in the conveying direction I.

In the corresponding manner, the second storage table 19 was positioned relative to the third track 9₃ before the slicing and the slices cut off from the product 3 in the third track 9₃ form a part portion 25 on the second storage table 19. In this respect, the storage tables 17, 19 are each rotated in the direction of rotation III during the slicing of the products 3 so that the cut off slices which form the respective part portion 23, 25 come to lie in the form of a part circle on the respective storage table 17, 19 (cf. FIG. 1).

Once the part portions 23, 25 have been completed, the two storage tables 17, 19 are moved in the transverse direction II. In this respect, the first storage table 17 is aligned relative to the second track 9₂ and the second storage table 19 is aligned relative to the fourth track 9₄.

Subsequently, the products 3 in the second track 9₂ and in the fourth track 9₄ are supplied to the cutting plane. A part portion 27 from the cut-off slices of the product 3 supplied via the second track 9₂ is in this respect formed on the first storage table 17. A part portion 29 of the cut-off slices of the product 3 supplied via the fourth track 9₄ is formed on the second storage table 19.

As can be seen from FIG. 2, each storage table 17, 19 is aligned with the respective track 9₂, 9₄ before preparing the respective part portions 27, 29 such that the part circle formed by the slices of the respective part portion 27, 29 continues the part circle which is formed by the slices of the respective previously prepared part portion 23, 25. The part portions 23, 25, 27, 29 form an approximately semi-circular portion overall on the respective storage table 17, 19 (cf. FIG. 2).

The two portions are combined to form a packaging unit, with the second storage table 19 first being rotated by 180° (cf. FIG. 3). Subsequently, the portions are supplied to a packaging unit 31 disposed after the storage tables 17, 19 in which the above-mentioned packaging unit is formed in circular shape from the two portions.

As mentioned, the apparatus 1 and the described method are examples to explain the invention. Another exemplary apparatus (not shown) can only have one movable storage table with which two or more tracks are associated and in which the cutting operation is carried out as was described above with respect to the first and second tracks 9₁, 9₂ and to the first storage table 17. In another exemplary apparatus, the storage tables are not designed as turntables, but rather as xy-tables adjustable in the longitudinal direction I and in the transverse direction II.

### REFERENCE NUMERAL LIST

1 apparatus
3 food product
5 product feed
7 product support
9₁ first track
9₂ second track
9₃ third track
9₄ fourth track
11 cutting plane
13 product gripper
15 carriage
17 first storage table
19 second storage table
21 axis of rotation
23 part portion
25 part portion
27 part portion
29 part portion
31 packaging unit
I conveying direction
II transverse direction
III direction of rotation

1. A method for multi-track slicing of a plurality of food products (3) into respective part portions (23, 25, 27, 29) comprising at least one product slice, in which method
a respective product (3) is supplied to a cutting plane (11) in at least two parallel tracks (9₁, 9₂, 9₃, 9₄) of a slicing apparatus (1) and is sliced by means of a cutting blade which is moved, wherein the slices of the at least two products (3) cut off by the cutting blade fall onto a common, movable storage table (17, 19),
wherein only one respective product (3) supplied in one of the tracks (9₁, 9₂, 9₃, 9₄) associated with the common storage table is exclusively sliced at any one time so that a maximum of one slice of the just sliced product (3) is incident on the common storage table (17, 19) at any one time.

2. A method in accordance with claim 1, wherein different types of food products are sliced into respective part portions (23, 25, 27, 29).

3. A method in accordance with claim 1, wherein the cutting blade moves in a revolving manner.

4. A method in accordance with claim 1, wherein a portion is formed on the common storage table (17, 19) which respectively comprises at least one part portion (23, 25, 27, 29) of each of the supplied products (3).

5. A method in accordance with claim 1, wherein a part portion (23, 25, 27, 29) comprising a plurality of slices is prepared on the storage table (17, 19) completely from a product (3) supplied in a track (9₁, 9₂, 9₃, 9₄), before the preparation of a part portion (23, 25, 27, 29) comprising a plurality of slices from a product (3) supplied in a different track (9₁, 9₂, 9₃, 9₄) is started.

6. A method in accordance with claim 1, wherein the common storage table (17, 19) is moved relative to the falling slices of a part portion (23, 25, 27, 29) such that the part portion (23, 25, 27, 29) is arranged on the storage table (17, 19) in a specific laying pattern.

7. A method in accordance with claim 6, wherein the laying pattern satisfies at least one predefined condition for the respective part portion (23, 25, 27, 29).

8. A method in accordance with claim 7, wherein the at least one predefined condition relates to the position of the part portion (23, 25, 27, 29) on the storage table and/or to the manner of the arrangement of each slice of the part portion (23, 25, 27, 29) and/or to the manner of the arrangement of the slices of the part portion (23, 25, 27, 29) relative to one another.

9. A method in accordance with claim 1, wherein the common storage table (17, 19) is moved in a time period in which no slicing takes place such that a part portion (23, 25, 27, 29) to be formed subsequently comes to lie in a specific position relative to a part portion (23, 25, 27, 29) already formed on the storage table (17, 19).

10. A method in accordance with claim 1, wherein the common storage table (17, 19) is rotated about an axis of rotation (21) orientated perpendicular to the storage table (17, 19) so that the slices forming a part portion (23, 25, 27, 29) come to lie in part circular form on the storage table (17, 19).

11. A method in accordance with claim 10, wherein a first part portion (23, 25) which includes the cut-off slices of a product (3) supplied in a track (9₁, 9₃) is prepared before a second part portion (27, 29) in time which includes the cut-off slices of a product (3) supplied in another track (9₂, 9₄), with the common storage table (17, 19) being moved in the time period lying between the preparation of the two part portions (23, 25, 27, 29) such that the part circle formed by the slices of the first part portion (23, 25) is continued by the slices of the second part portion (27, 29).

12. A method in accordance with claim 1, wherein the slicing apparatus (1) has at least one further track (9₃, 9₄) in which a further product (3) is supplied to the cutting plane (11) and can be sliced by means of the cutting blade, with the cut-off slices of the further product (3) falling onto a further, second storage table (19) which is movable independently of the first storage table (17) and on which the portion preparation takes place in the same manner as on the first storage table (17).

13. A method in accordance with claim 12, wherein part portions (25, 29) are prepared on the second storage table (19) parallel in time with part portions (23, 27) on the first storage table (17).

14. A method in accordance with claim 12, wherein the portions formed on the two support tables (17, 19) are combined to form a packaging unit.

15. A method in accordance with claim 12, wherein the second storage table (19) is moved relative to the first storage table (17) to align the portion on the second storage table (19) relative to the portion on the first storage table (17).

16. A method in accordance with claim 15, wherein the second storage table is rotated by a specific angle relative to the first storage table (17).

17. A method in accordance with claim 1, wherein each part portion (23, 25, 27, 29) satisfies a condition predefined for the respective track (9₁, 9₂, 9₃, 9₄).

18. A method in accordance with claim 17, wherein the condition relates to the weight of the part portion (23, 25, 27, 29), to the weight and/or to the thickness of the slices forming the part portion (23, 25, 27, 29) and/or to the number of the slices forming the part portion (23, 25, 27, 29).

19. An apparatus for multi-track slicing of a plurality of food products (3) into respective part portions (23, 25, 27, 29) comprising at least one product slice, comprising
a product feed (5) which has at least two parallel tracks (9₁, 9₂, 9₃, 9₄), wherein a product (3) can be supplied in each track (9₁, 9₂, 9₃, 9₄) to a cutting plane (11) individually by a track;
at least one cutting blade which is movable in the cutting plane (11); and
a movable common storage table (17, 19) which is disposed after the cutting plane (11) and onto which the slices of the at least two products (3) cut off by the cutting blade can fall,
wherein the apparatus (1) is designed respectively to slice only one product (3) supplied in one of the tracks (9₁, 9₂, 9₃, 9₄) associated with the common storage table (17, 19) exclusively at any one time so that a maximum of one cut-off slice of the just sliced product (3) is incident on the common storage table (17, 19) at any one time.

20. An apparatus in accordance with claim 19, wherein the apparatus is adapted to slice different types of food products into respective part portions (23, 25, 27, 29).

21. An apparatus in accordance with claim 19, wherein the cutting blade is adapted to move in a rotating or revolving manner in the cutting plane.

22. An apparatus in accordance with claim 19, wherein the common storage table (17, 19) is coupled to a controllable motor drive, whereby the storage table (17, 19) can be moved relative to the falling slices of a part portion (23, 25, 27, 29) such that the part portion (23, 25, 27, 29) is arranged on the storage table (17, 19) in a specific laying pattern; and/or
wherein the storage table (17, 19) is movable in a time period in which no slicing takes place such that a part portion (27, 29) to be formed subsequently comes to lie in a specific position relative to a part portion (23, 25) already formed on the storage table (17, 19).

23. An apparatus in accordance with claim 19, wherein the storage table (17, 19) is designed as a turntable which is rotatable about a vertical axis of rotation (21) passing centrally through the turntable and/or is movable transversely to the conveying direction (I) of the products (3).

24. An apparatus in accordance with claim 19, wherein the product feed (5) includes at least one further track (9₃, 9₄) in which a further product (3) can be supplied to the cutting plane individually by a track and the slices of the at least one product (3) cut off by the cutting blade and supplied in the at least one further track (9₃, 9₄) fall onto a second storage table which is movable in the same manner as the first storage table (17) and independently of the first storage table (17).
